(19) United States
(12) Patent Application Publication
(10) Pub. No.: US 2022/0297471 A1
(43) Pub. Date: Sep. 22, 2022

(54) Paintbrush Holder for Paint Containers

(71) Applicant: Fred Aviguetero, Waimea, HI (US)

(72) Inventor: Fred Aviguetero, Waimea, HI (US)

(21) Appl. No.: 17/667,719

(22) Filed: Feb. 9, 2022

Related U.S. Application Data
(60) Provisional application No. 63/164,109, filed on Mar. 22, 2021.

(51) Int. Cl. B44D 3/12

(52) U.S. Cl. CPC B44D 3/123

(57) ABSTRACT

The present invention relates to a paintbrush and paint roller holder for paint buckets/cans/containers. More specifically, the invention relates to a cylindrical or cuboidal body paintbrush holder attached to a generally P-shaped clip, that enables the holder to mount to a rim of a paint bucket. The holder structure enables a user to easily place the paintbrush or the paint roller inside the cavity of cuboidal holder or cylindrical holder respectively. The generally P-shaped clip enables the holder to easily slide around the rim of the paint bucket, to enable the users to quickly and easily access the paintbrush or paint roller kept inside the holder. The paintbrush holder can also include a sleeve for color identification to enable a user to distinguish between different paintbrushes and/or paint container colors.

### CROSS-REFERENCE TO RELATED APPLICATION

The present application claims priority to, and the benefit of, U.S. Provisional Application No. 63/164,109, which was filed on Mar. 22, 2021 and is incorporated herein by reference in its entirety.

### FIELD OF THE INVENTION

The present invention relates generally to the field of painting aids. More specifically, the present invention relates to a paintbrush holder that offers an accessible location to place a paintbrush while painting. The paintbrush holder can be easily clipped to the outside of a paint container (i.e. paint can or paint bucket) in order to ensure the paintbrush is always within the reach of the user. The holder is generally a cuboidal body structure with a top face open portion to enable a user to keep the paintbrush inside the holder cavity and to remove the paintbrush from the holder. Additionally, the holder features a spring-style clip that fits snugly to the rim of the paint can/bucket and enables the holder to be hung while painting using paintbrushes. The holder can also be provided with sleeves to enable the user to distinguish between different paintbrushes while using multicolored paints. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, painting a wall of a building, a room or other object is a time-consuming process and is a messy task. Generally, painting involves climbing ladders and other elevated surfaces to reach the desired location to paint the wall surface. While climbing up on a ladder or any elevated surface, a painter usually takes a paint can or bucket holding paint inside it, along with a paint brush and rollers for painting the wall. Painting an entire wall or room takes several hours to complete the work, and painters may be required to take breaks or attend other tasks during the painting work. However, in order to take a break from painting tasks, the painters are required to place their paint brush somewhere to pause the painting task. Also, while using a roller for painting walls or objects, painters are required keep their paintbrush at-the-ready and switch to rollers. The in-use paintbrushes are wet with paints/stains, and people may struggle to find a proper location to place their paintbrush. Wet paintbrushes, when kept at a temporary location, cause their bristles to get paint on any object or surface upon which it is placed, creating another clean-up area.

Keeping the brush in the paint tray is not a workable option, because it will be in the way of the roller. It is especially difficult to find a place to temporarily retain a brush when painting from a ladder. Balancing the brush on the paint can or on a ladder step often leads to messy paint drips and spilled paint.

Some individuals may place the paintbrush within a paint bucket as an alternative from keeping the brush somewhere else. However, the brush, when kept within the paint bucket, causes the paint inside the bucket to get all over the brush handle and bristles. Brushes full of paint, when held by painters, cause the paint to transfer to the hands of the painter. The painters or paintbrush operators can have a tough time in cleaning their hands afterwards.

Therefore, there exists a long felt need in the art for a device that enables the painters and other paintbrush operators to easily hold a paintbrush(s) while painting walls of rooms, buildings or any other object. There is also a long felt need in the art for a holding device that can be easily carried by painters/operators while climbing up the ladder or any other elevated surface for painting tasks. Additionally, there is a long felt need in the art for a paintbrush holder that prevents the operators from keeping wet paintbrushes at random places, and therefore prevents additional surfaces from getting dirty due to the dripping of paint from wet paintbrushes. Moreover, there is a long felt need in the art for a paintbrush-holding device that makes it easy for the painters/operators to take breaks from painting tasks or attend to other tasks, while securely keeping their wet paintbrushes at-the-ready. Further, there is a long felt need in the art for a paintbrush holder that makes it easy to switch between rollers and brushes while performing painting tasks. Furthermore, there is a long felt need in the art for a paintbrush-holding device that eliminates the need to place paintbrushes in a paint tray or within a paint can/bucket, and prevents the handles of the paintbrushes from becoming covered with paint. Finally, there is a long felt need in the art for a paintbrush holder that enables the paintbrushes to be kept at an accessible location, and makes the painting process easier, especially when painting from a ladder or other elevated surface.

The subject matter disclosed and claimed herein, in one potential embodiment thereof, comprises a paintbrush holder for a paint container. The paintbrush holder includes a clip body structure that easily fits onto the rim of the paint container such as a paint bucket, paint can or the like. The paintbrush holder further comprises a generally cuboidal body holder structure that is attached to a generally P-body clip wherein the clip rests onto the rim. The cuboidal body holder includes one face open, to enable a user to place the paintbrush inside the cavity of the cuboidal body holder when the brush is not in use. The generally P-body clip enables the holder to easily slide, move or circumscribe around the bucket rim to provide quick and easy access to paintbrushes.

In this manner, the novel paintbrush holder of the present invention accomplishes all of the forgoing objectives, and provides a relatively safe, easy and convenient solution to keep the paintbrush at an accessible location while performing painting tasks. The paintbrush holder of the present invention is also user-friendly, as it enables the painters or paintbrush operators to take breaks from tedious and time-consuming painting tasks, without worrying about finding a place to keep the wet paintbrushes. Additionally, the paintbrush holder can slide or circumscribe around the paint can/bucket to make the brush easily accessible to the users. A paintbrush holder sleeve can also be provided along with the paintbrush holder, so as to enable the users to use different-colored sleeves with holders to hold brushes used with different colors, and enables the users to easily distinguish between the brushes without removing the paintbrush from each holder. The holder can also include a disposable liner for temporary or one time use that can be disposed of after use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one potential embodiment thereof, comprises a paintbrush holder for a paint container. The paintbrush holder includes a clip body structure that easily fits onto the rim of the paint container such as a paint bucket, paint can or the like. The paintbrush holder further comprises a generally cuboidal body holder structure that is attached to a generally P-body clip wherein the clip rests or clips onto the rim. More specifically, the cuboidal body structure includes four walls; a rear wall, a front wall and a pair of side walls extending from a base, thereby forming a cavity to store a paintbrush therein. The clip includes a longitudinal arm fastened to the rear wall through a mechanical fastener, a U-shaped bend resting on the rim of the container, and a ridge for catching the container with the longitudinal arm. The clip also includes a gripping section to pull the ridge away from the longitudinal arm.

In a further embodiment of the present invention, a paintbrush holder configured to mount to the rim of a paint bucket is disclosed. The holder includes a cuboidal or cylindrical holder body, a generally P-body clip attached to the body, wherein the cuboidal or cylindrical holder body is attached to the generally P-body clip through a mechanical fastener such as a screw. The generally P-body clip includes a U-shaped bend that rests on the rim of the bucket. The cuboidal or cylindrical holder body stores a paintbrush, and can be covered by a sleeve of a particular color to indicate the color of the paint stored in the paint bucket. In use, the paintbrush holder slides around the rim of the bucket. The sleeve can be replaceable when painting with more than one color. Additionally, a disposable liner can be used to line the interior of the holder for a one-time use and easy clean-up.

In a further embodiment of the present invention, the paintbrush holder can be used for holding a variety of paintbrushes and with a variety of paint buckets and cans. The paintbrush holder is washable, and ensures that the paintbrush is always within reach when needed. The paintbrush holder enables users to paint with both a brush and a roller without having to search for a place to set the brush while rolling paint.

In a further embodiment of the present invention, a method of attaching a paintbrush holder to a rim of a paint bucket is described. The method comprises the initial step of covering the paintbrush holder with a sleeve of a desired color, positioning a U-shaped bend of clip over the rim of the bucket such that a longitudinal arm with attached holder body is disposed over an exterior surface of the bucket, and a ridge and curved arm portion of the clip disposed over an interior surface of the bucket.

In yet another embodiment of the present invention, a method of attaching a paintbrush holder to the rim of a paint bucket is described. The method comprises: positioning a U-shaped bend of the clip over the rim of the bucket, such that a longitudinal arm with attached holder body is disposed over an exterior surface of the bucket, and a ridge and curved arm portion of the clip disposed over an interior surface of the bucket; and, pulling the gripping portion of the clip to fit the clip at a desired position over the rim and storing a paintbrush in the cavity of a holder body.

In yet a further embodiment of the present invention, the paintbrush holder of the present invention can be easily and efficiently manufactured and marketed. The paintbrush holder is of a durable and reliable construction. The new paintbrush holder is susceptible of a low cost of manufacture with regard to both materials and labor, and which accordingly is then susceptible of low prices of sale to the consuming public, thereby making such paintbrush holder economically available to the buying public.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of paintbrush holder of the present invention in accordance with the disclosed architecture;

FIG. 2 illustrates a perspective view of one potential embodiment showing a metal clip used for mounting the paintbrush holder of the present invention to the rim of a paint bucket or can in accordance with the disclosed architecture;

FIG. 3 illustrates a perspective view of one potential embodiment of the paintbrush holder 100 for a paint container of the present invention in accordance with the disclosed architecture and about to be installed over a rim portion 302 of a paint container 300;

FIG. 4 illustrates a perspective view of one potential embodiment of the paintbrush holder 100 for a paint container of the present invention in accordance with the disclosed architecture and installed over a rim portion 302 of a bucket 300;

FIG. 5 illustrates a perspective view of one potential embodiment of the paintbrush holder 100 for a paint container of the present invention in accordance with the disclosed architecture and installed over a rim portion 302 of a bucket 300 with a stored paintbrush 502; and

FIG. 6 illustrates a perspective view of another potential embodiment of the paintbrush holder 100, 600 for a paint container of the present invention in accordance with the disclosed architecture and installed over a rim portion 302 of a bucket 300.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that enables painters and other paintbrush operators to easily hold a paintbrush(s) while painting walls of rooms, buildings or any other object. There is also a long felt need in the art for a holding device that can be easily carried by painters/operators while climbing up the ladder or any other elevated surface for painting tasks. Additionally, there is a long felt need in the art for a paintbrush holder that prevents the operators from setting wet paintbrushes in random locations and therefore prevents additional surfaces from getting dirty due to the dripping of paint from wet paintbrushes. Moreover, there is a long felt need in the art for a paintbrush-holding device that makes it easy for the painters/operators to take breaks from painting tasks or attend to other tasks, while securely keeping their wet paintbrushes at-the-ready. Further, there is a long felt need in the art for a paintbrush holder that makes it easy to switch between rollers and brushes while performing painting tasks. Furthermore, there is a long felt need in the art for a paintbrush-holding device that eliminates the need to place paintbrushes in a paint tray or within a paint can/bucket, and prevents the handle of the paintbrushes from becoming covered with paint. Finally, there is a long felt need in the art for a paintbrush holder that enables the paintbrushes to be kept at an accessible location and makes the painting process easier, especially when painting from a ladder or other elevated surface.

The present invention, in one potential embodiment, includes a paintbrush holder configured to mount to a rim of a paint bucket or can. The holder includes a cuboidal or cylindrical holder body, a generally P-body clip attached to the body, wherein the cuboidal or cylindrical holder body is attached to the generally P-body clip through a mechanical fastener such as a screw. The generally P-body clip includes a U-shaped bend that rests on the rim of the bucket. The cuboidal or cylindrical holder body stores a paintbrush and can be covered by a sleeve of a particular color to indicate the color of the paint stored in the paint bucket. In use, the paintbrush holder slides around the rim of the bucket. The sleeve can be replaceable when painting with more than one color. Additionally, a disposable liner can be used to line the interior of the holder for a one-time use and easy clean-up.

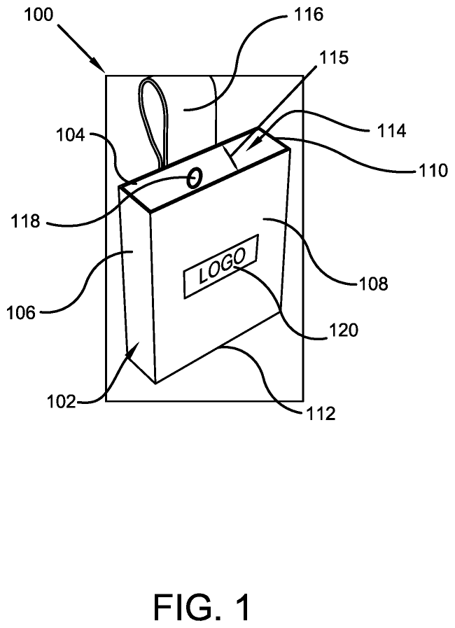

Referring to the drawings, FIG. 1 illustrates a perspective view of one potential embodiment of a paintbrush holder of the present invention in accordance with the disclosed architecture. The paintbrush holder 100 is configured to be mounted to the rim of a paint can or paint bucket, and holds a paintbrush for easy access during the painting process, especially when painting from a ladder. More specifically, the paintbrush holder 100, in one potential embodiment, includes a generally cuboidal body construction 102 that includes a cavity 114 formed by four walls 104, 106, 108, 110 extending from a base 112. As a point of reference, the rear wall 104 refers to the wall positioned adjacent to a paint can or paint bucket, and includes a generally P-body spring clip 116 detachably-attached to it with a mechanical fastener 118. A front wall 108 is parallel and opposite to the rear wall 104, and together with the pair of side walls 106, 110 forms the cavity 114.

As explained more fully below, the paintbrush holder 100 of the present invention is designed to be mounted on a rim portion of a paint can or paint bucket. In operation, the paintbrush holder 100 provides a space 114 to securely keep a paintbrush such that a user does not need to search for the paintbrush or store the paintbrush at an inconvenient location during the painting process. To mount the paintbrush along the rim of a paint bucket, the clip 116 attached to the rear wall 104 can be clipped across the rim to snugly fit the paintbrush holder 100 to the bucket. The front wall 108 may further comprise different indicia 120, such as designs, patterns, a company logo, personalized name, customized design or the like as per the requirements of the user. The indicia 120 may also include a color that can be used to indicate color of a paint stored in the paint bucket or can.

The spring clip 116 can be replaced with a new spring clip using the mechanical fastener 118. The paintbrush holder 100 can be easily mounted or unmounted using the spring clip 116 around the rim of the paint bucket or paint can.

The cuboidal body 102 of the holder 100 can be made up of plastic, polycarbonate or metal. In the present embodiment, the dimensions of the body 102 can be generally about 4″ to 6″ in height (H), and about 3″ to 6″ in width (W). The cavity opening 115 can be in the range generally from about 0.5″ to about 2.5″. The spring clip 116 can be constructed of stainless steel or any sturdy spring-like metal. A disposable liner 130 can be inserted into the interior of the paintbrush holder 100. The liner 130 can be made from a material such as, but not limited to, a flexible plastic. It is to be appreciated that the dimensions of the liner 130 are slightly less than the interior dimensions of the holder 100 for easy insertion. After use, the liner 130 can be pulled and removed from the holder 100, and subsequently disposed of. The disposable liner 130 can be a single-use liner that obviates the need to clean paint from the interior of the holder 100 between uses.

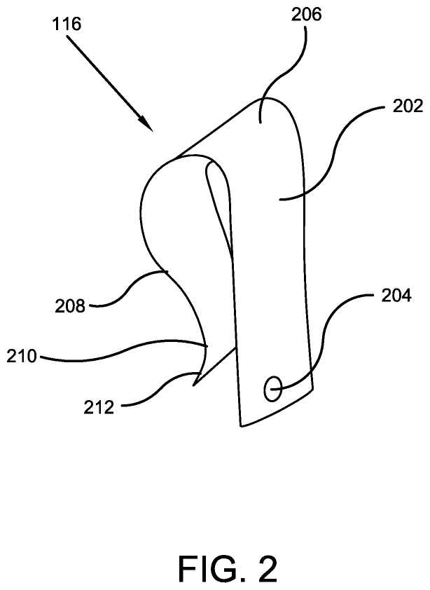

FIG. 2 illustrates a perspective view showing a metal clip used for mounting the paintbrush holder of the present invention to a rim of a paint bucket or paint can in accordance with the disclosed architecture. The clip 116 can include a single body structure and clips the paintbrush holder 100 over a rim of a paint container (i.e. paint bucket or paint can). The clip 116 includes a longitudinal arm 202 that includes a hole 204 for receiving a mechanical fastener to fasten to a rear wall 104 of the cuboidal body 102. By way of reference, the longitudinal arm 202 is positioned adjacent to the rear wall 104 of the paintbrush holder 100 and outer surface of the paintbrush bucket. A U-shaped bend 206 connects the longitudinal arm portion 202 and a curved arm portion 208. A ridge 210 in continuation to the curved arm portion 208 catches the bucket surface in between the ridge 210 and the longitudinal arm 202. The ridge 210 touches an interior surface of a bucket, while the longitudinal arm 202 touches the exterior surface the bucket. A gripping section 212 is used by a user to pull the ridge 210 and the curved arm portion 208 away from the longitudinal arm 202, to remove the clip from a rim or any other surface. When the gripping section 212 is release, the ridge 210 retains the original position to come adjacent to the longitudinal arm 202.

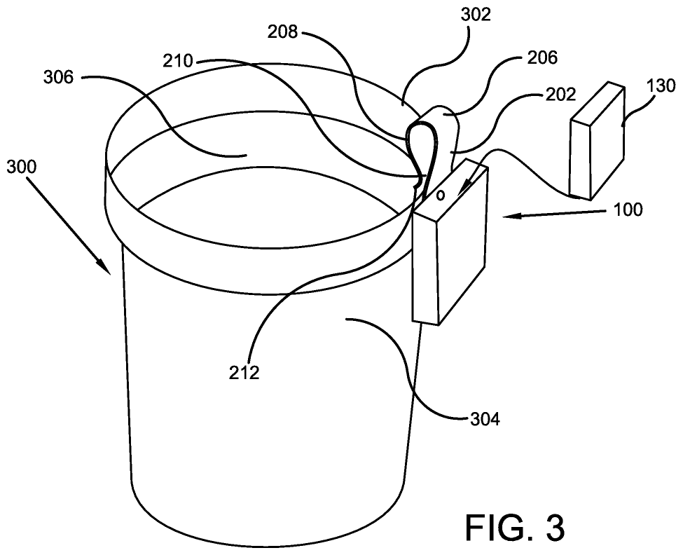

FIG. 3 illustrates a perspective view of one potential embodiment of the paintbrush holder 100 for a paint container of the present invention in accordance with the disclosed architecture. As illustrated, the holder 100 is positioned for installation over a rim portion 302 of a paint container 300. Although the paint container 300 is illustrated as a bucket, it is to be appreciated that the term as used herein encompasses any bucket made from any material, including, but not limited to: cans, containers, and the like. More specifically, a user (not shown) attaches the paintbrush holder 100 to the bucket 300 by slipping it over the rim portion 302 of the bucket 300, such that the longitudinal arm 202 remains on an exterior 304 of the bucket 300, and the curved portion 208, ridge 210 and gripping portion 212 remain on the interior 306 of the bucket 300. The U-shaped bend 206 remains over the rim 302 and the gripping portion 212 is pulled away from the longitudinal arm 202 to provide a spring clip force to the bucket such that the U-shaped bend 206 sits over the rim 302. In operation, the paintbrush holder 100 sits securely on the rim 302 of the bucket 300, thereby enabling the user to place a paintbrush in the cuboidal body 102 for temporary placement and/or storage.

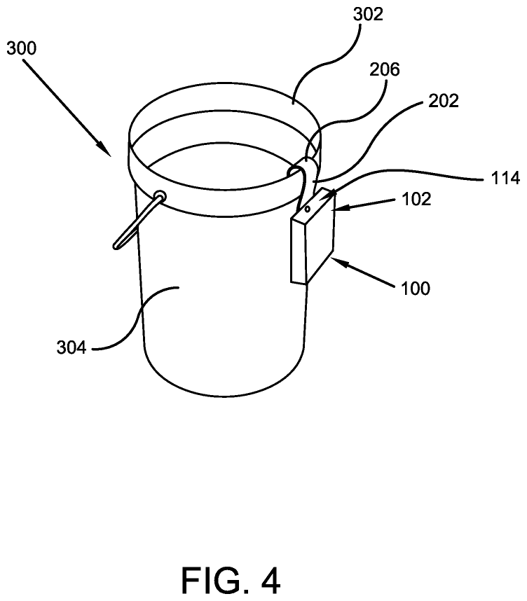

FIG. 4 illustrates a perspective view of one potential embodiment of the paintbrush holder 100 for a paint container of the present invention in accordance with the disclosed architecture and installed over a rim portion 302 of a bucket 300. More specifically, the paintbrush holder 100 is removably attached and configured to slide or move around the rim 302. As shown in FIG. 4, the U-shaped bend portion 206 sits over the rim 302 and the cuboidal body 102 of the holder 100 that is attached to the longitudinal arm 202 lies on the exterior 304 of the bucket 300. The cavity 114 is used for storing a paintbrush for easy storage and access during the painting process.

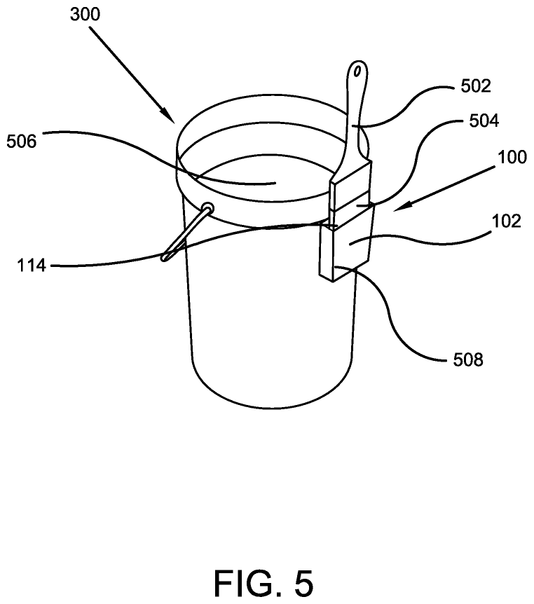

FIG. 5 illustrates a perspective view of one potential embodiment of the paintbrush holder 100 for a paint container of the present invention in accordance with the disclosed architecture and installed over a rim portion 302 of a bucket 300 with a stored paintbrush 502. In operation, a sleeve 508 of a particular color that is available commercially with the paintbrush holder 100 covers the cuboidal body 102 to indicate color of the paint 506 stored in the bucket 300. A paintbrush 502 having painting bristles 504 is stowed in the cavity 114 for secure and easy storage and access. The holder ensures that the paintbrush 502 is always within reach when needed, and makes the painting process easier, especially when painting from a ladder. The sleeve 508 can be replaced easily with a sleeve of a different color, thereby enabling painters to identify the correct bucket for painting.

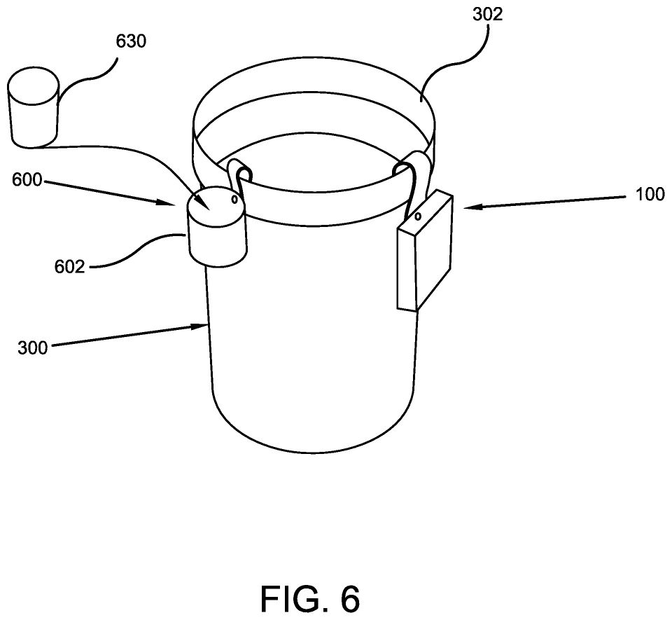

FIG. 6 illustrates a perspective view of potential embodiments of the paintbrush holder 100, 600 for a paint container of the present invention in accordance with the disclosed architecture and installed over a rim portion 302 of a bucket 300. In the present embodiment, the paintbrush holder 100 and a paint roller holder 600 can be mounted on the rim 302 of the bucket 300. The paint roller holder 600 can be configured to store a cylindrical paint roller in the cylindrical body 602. The clip and the attachment for mounting the paint roller holder 600 to the rim 302 is similar to the construction as described above for the paintbrush holder 100. A disposable liner 630 can be inserted into the interior of the paintbrush holder 600. The liner 630 can be made from a material including flexible plastic. It is to be appreciated that the dimensions of the liner 630 are slightly less than the interior dimensions of the holder 600 for easy insertion. After use, the liner 630 can be pulled and removed from the holder 600, and subsequently disposed of. The disposable liner 630 can be a single-use liner that obviates the need to clean paint from the interior of the holder 600 between uses.

The paintbrush holder 100 and paint roller holder 600 can be made available in different sizes and colors to accommodate user needs and/or preferences. The exact size, measurement, construction and design specifications of the paintbrush holder 100 and paint roller holder 600 of the present invention can vary upon manufacturing or the particular material that is used. As stated above, the paintbrush holder 100 and paint roller holder 600 can further comprise logos, indicia 120, trademarks, geometric patterns, customizable colors and fonts, prints and/or images on its surface. Further, the paintbrush holder 100 and paint roller holder 600 can comprise durable, sturdy and washable materials.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paintbrush holder”, “paintbrush holding device” and “holder”, are interchangeable and refer to the paintbrush holder 100 of the present invention.

Notwithstanding the forgoing, the paintbrush holder 100 and paint roller holder 600 of the present invention can be of any suitable size and configuration as is known in the art without affecting the overall concept of the invention, provided that it accomplishes the above-stated objectives. One of ordinary skill in the art will appreciate that the size, configuration, and material of the paintbrush holder 100 and paint roller holder 600 as shown in the FIGS. are for illustrative purposes only, and that many other sizes and shapes of the paintbrush holder 100 and paint roller holder 600 are well within the scope of the present disclosure. Although the dimensions of the paintbrush holder 100 and paint roller holder 600 are important design parameters for user convenience, the paintbrush holder 100 and paint roller holder 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paintbrush holder for selective placement on a rim of a paint container, the paintbrush holder comprising:
a holder having a cuboidal shaped and comprised of four walls, a base and an open top; and
a clip attached to a rear wall of said holder, wherein said clip is generally P-shaped and comprises a longitudinal arm fastened to said rear wall of said holder, and further wherein said clip further comprises a U-shaped bend for resting on the rim of the paint container and a ridge and a gripping section for grasping a side of said paint container.

2. The paintbrush holder of claim 1, wherein said clip is a spring clip.

3. The paintbrush holder of claim 2 further comprising a liner for insertion into said holder, wherein said liner lines an interior of said four walls and said base of said holder.

4. The paintbrush holder of claim 3, wherein said liner is constructed of a flexible plastic.

5. The paintbrush holder of claim 4, wherein said liner is disposable.

6. The paintbrush holder of claim 5, wherein said paint container is selected from a group consisting of a paint can and a paint bucket.

7. The paintbrush holder of claim 2, wherein said holder further comprises a sleeve for housing a paint color sample to identify a paint color within said paint container.

8. A paint roller holder for selective placement on a rim of a paint container, the paint roller holder comprising:
a cylindrically shaped holder, wherein said cylindrically shaped holder includes a cylindrical wall, a base, and an open top,
a clip attached to a rear wall of said cylindrically shaped holder, wherein said clip is generally P-shaped;
said clip includes a longitudinal arm fastened to said rear wall of said cylindrically shaped holder;
said clip further includes a U-shaped bend for resting on the rim of the paint container; and
said clip further includes a ridge and a gripping section for grasping a side of said container.

9. The paint roller holder of claim 8, wherein said clip is a spring clip.

10. The paint roller holder of claim 9 further comprising a liner for insertion into said cylindrically shaped holder, wherein said liner lines an interior of said cylindrical wall and said base of said cylindrically shaped holder.

11. The paint roller holder of claim 10, wherein said liner is constructed of a flexible plastic.

12. The paint roller holder of claim 11, wherein said liner is disposable.

13. The paint roller holder of claim 12, wherein said paint container is selected from a group consisting of a paint can and a paint bucket.

14. The paint roller holder of claim 9, wherein said cylindrically shaped holder further comprises a sleeve for housing a paint color sample to identify a paint color within said paint container.

15. A paintbrush holder for selective placement on a rim of a paint container, the paintbrush holder comprising:
a holder comprised of four walls, a base and an open top,
a spring clip attached to a rear wall of said holder, wherein said spring clip is generally P-shaped;
said spring clip includes a longitudinal arm fastened to said rear wall of said holder;
said spring clip further includes a U-shaped bend for resting on the rim of the paint container;
said spring clip further includes a ridge and a gripping section for grasping a side of said container; and
a disposable liner for insertion into said holder, wherein said liner lines an interior of said four walls and said base of said holder.

16. The paintbrush holder of claim 15, wherein said liner is constructed of a flexible plastic.

17. The paintbrush holder of claim 16, wherein said liner is a single-use liner.

18. The paintbrush holder of claim 17, wherein said paint container is selected from a group consisting of a paint can and a paint bucket.

19. The paintbrush holder of claim 18, wherein said holder further comprises a sleeve for housing a paint color sample to identify a paint color within said paint container.

20. The paintbrush holder of claim 17, wherein said holder is cuboidal in shape.
